(19) United States
(12) Patent Application Publication
(10) Pub. No.: US 2009/0189495 A1
(43) Pub. Date: Jul. 30, 2009

(54) INTEGRATED COMMAND CENTER FOR FLAT SCREEN TELEVISIONS, AND INTERNET PROTOCOL MONITORS

(76) Inventor: Gary Rein, New York, NY (US)

Correspondence Address: KEITH D. NOWAK, CARTER LEDYARD & MILBURN LLP, 2 WALL STREET, NEW YORK, NY, 10005, US

(21) Appl. No.: 12/413,165

(22) Filed: Mar. 27, 2009

Related U.S. Application Data
(63) Continuation-in-part of application No. 11/519,304, filed on Sep. 11, 2006, now abandoned.
(60) Provisional application No. 60/835,404, filed on Aug. 2, 2006.

(51) Int. Cl. H04N 5/64

(52) U.S. Cl. 312/223.6

(57) ABSTRACT

A wall mountable media control system locatable adjacent a wall mounted video screen comprising a wall mountable media control center capable of controlling a plurality of different types of information data and having at least one output connection for each of said different types of information data for connection of wiring from said wall mountable media control center to said wall mounted video screen, at least one of said plurality of different types of information data being selectively enableable by a service provider of said information data, said plurality of different types of information data being accessible by command of a user of said wall mountable media control center; a plurality of wall mountable cowls locatable between said wall mountable media control center and said wall mounted video screen, said plurality of wall mounted cowls being sized and shaped to cover said wiring connecting said wall mountable media control center and said wall mounted video screen, said plurality of wall mountable cowls being interconnectable with one another by integral connection components; and a modular information data receiver addition connectable to said wall mounted media control center, said modular information data receiver addition adapted to receive information data not initially receivable by said wall mountable media control center.

### CROSS REFERENCE TO RELATED APPLICATIONS

This application is a continuation application of U.S. Non-Provisional patent application Ser. No. 11/519,304, entitled “Integrated Command Center for Flat Screen Televisions, and Internet Protocol Monitors” filed on Sep. 11, 2006, which claims the benefit of, under 35 USC § 119(e), U.S. Provisional Patent Application Ser. No. 60/835,404, filed Aug. 2, 2006, both of which are incorporated by reference herein in their entirety. A related application, U.S. Non-Provisional patent application Ser. No. 12/019,727, entitled “Integrated Command Center for Flat Screen Televisions, and Internet Protocol Monitors” was filed on Jan. 25, 2008, which is a continuation-in-part application of U.S. Non-Provisional patent application Ser. No. 11/519,304 cited above.

### FIELD OF THE INVENTION

The present invention relates to enhancing the capability and appearance of flat screen televisions, and IP Monitor installations and more particularly to a command center which remotely enables a plurality of incoming information signals that are controlled from a central station, while eliminating the disadvantages in function, and appearance of the standard cable set-top box.

### BACKGROUND OF THE INVENTION

It is well known that the communications industry is consolidating. Where once there were separate providers for television, telephone and the internet, today all three communication media are often supplied by a single provider. This is especially true for the cable industry.

Prior to the current drive for consolidation, cable companies typically provided a television signal to the consumer through use of the standard set-top box. The name “set-top box” (“STB”) is derived from the fact that the box which provided the television signal to the consumer typically was placed on top of the standard television set with the cable connection to the set-top box visible to the consumer. This type of installation functioned well over several decades, but has become increasingly inappropriate, unsightly, and difficult to install with the increasing use of flat screen televisions which are designed primarily for wall mounting. In addition, the number of secondary visible component connections increases with every new service feature.

A second problem with the standard set-top box is that it was designed only to provide a television signal to the consumer. Today a typical consumer's home not only has several televisions which can display HDTV or IPTV, but may also have a DVD/DVR player, an internet connection, a home entertainment center, plus, of course, telephone service. For a cable company providing more than just a television signal to the consumer the standard set-top box is only one of many STB-type component devices that must be installed at a consumer's home, with additional devices needed for internet, telephone or other entertainment services.

It is therefore an object of the present invention to provide a single command center device which already has the numerous internal components integral into the single unit to receive a plurality of incoming communication signals, is minimally invasive to the home environment, and attractive to the consumer, and can be selectively remotely enabled by a provider such as a cable company.

### SUMMARY OF THE INVENTION

The present invention simultaneously integrates multiple internal incoming signals; Digital cable, telephony, Internet, HDTV, IPTV, internal surveillance, and other signals, along with an integral DVD/DVR player, i-Pod docking station, and power-surge protector, into a single wall-mounted, provider selectively enabled “Command Center” housing, which transforms the 30 year old current set-top box industry standard. With the number of flat-screen TV's approaching 40 million, the existing set-top box, as we know it, faces extinction.

The invention incorporates the internal elements into a wall-mounted housing that attaches directly under a Flat-screen TV, or monitor, and projects approximately 3″ off the wall. A series of modular “cowl” elements slide or telescope into position, using integral dovetails to conceal multiple wire connections to the device. A secondary extrusion is provided, which has an integral track for a slide-in color-coded fascia panel, for the final telephone, and AC power cord to the external outlet.

Future provisions for 802.11n integrated chip WIFI cordless connections will ultimately result in the AC power cord as the only external connection required. Secondary in-home slave units for remote locations to the Command Center also utilize WIFI connections.

In addition, the invention provides that each specific signal is individually remotely enabled by the cable provider to the end user, to allow multi-tier service from the single Command Center unit. Once activated, the end-user interface is also activated by means of a remote controller.

The invention allows the cable provider to provide the end user with a single wall-mounted unit, (instead of multiple unit individual STB's that are currently distributed,) to connect the end-user with each additional service feature. In doing so, the cost of providing multiple service feature access is front loaded into the production of a single universal unit, instead of the manufacturing inefficiencies of variable quantity limited production units.

The rapidly changing features, and delivery technologies, have been necessitating continual hardware upgrades, and therefore difficulties in accurate production quantity projections. By creating a single Command Center, the inventory obsolescence, and component waste is also radically reduced, thereby creating a streamlined, cost-efficient production chain.

Furthermore, the distribution, time to market, and service costs associated with the implementation of service to the customer is also radically reduced, creating significant cost efficiencies in this highly competitive marketplace.

End-user advantages include: significant space efficiency by utilizing a single command center unit, multi-tier add-on menu driven price options, and overall ease of use associated with a single consolidated unit.

### BRIEF DESCRIPTION OF THE DRAWINGS

The present disclosure may be better understood and its numerous features and advantages made apparent to those skilled in the art by referencing the accompanying drawings wherein:

FIG. 1 is a perspective view of the invention and its manner of connection to a flat screen television; and

FIG. 2 is a block diagram of the invention and its manner of connection to a plurality of incoming information signals.

### DETAILED DESCRIPTION OF THE INVENTION

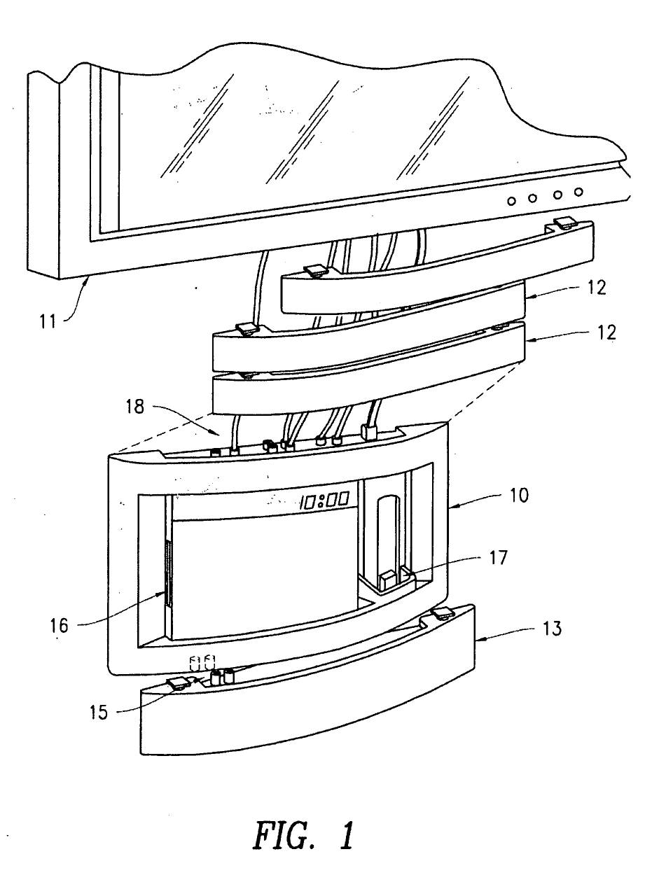

Referring now to FIG. 1, there is shown a view of the invention and how it is used in conjunction with a flat screen television.

More particularly, the Command Center shown at 10 replaces the standard set-top box and accommodates a plurality of incoming information signals as will be described below. The Command Center can also accommodate a DVD/DVR player with the DVD slot shown at 16, as well as an i-Pod docking nest shown at 17.

Hardwire connection terminals on Command Center 10 are shown at 18, which allows the Command Center to be connected to flat screen television 11. The actual wires extending from the Command Center 10 to flat screen television 11 will be hidden from view by one or more hollow modular cowls shown at 12. It is to be understood that for this embodiment of the invention, flat screen television 11 is wall-mounted with Command Center 10 wall mounted below the flat screen television. The number of modular cowls required for a particular installation will depend on the distance desired between the Command Center and the television.

An alternative to the plurality of modular cowls shown in FIG. 1 is a telescoping cowl that would be connected to the top of Command Center 10 and extendable in a telescoping fashion from the top of the Command Center 10 to the bottom of the flat screen TV 11. Other embodiments are also possible. As one of the primary purposes of the wall mounted Command Center is to improve the appearance of a TV/STB combination the cowl argument is an advantageous feature of the invention. Once in place all wiring between the Command Center and the flat screen TV is concealed providing a significant improvement in overall appearance.

Mounted below the Command Center are a plurality of modules to accommodate post-production future incoming information signals not already manufactured into the unit. For example, module 13 will contain the necessary hardware and/or software to handle incoming information signals not already accommodated by Command Center 10. Each module will connect to adjacent modules with a hot-shoe connector 15 or equivalent. It is to be understood that a plurality of modules can be added to Command Center 10, each of which would be able to handle a particular incoming information signal.

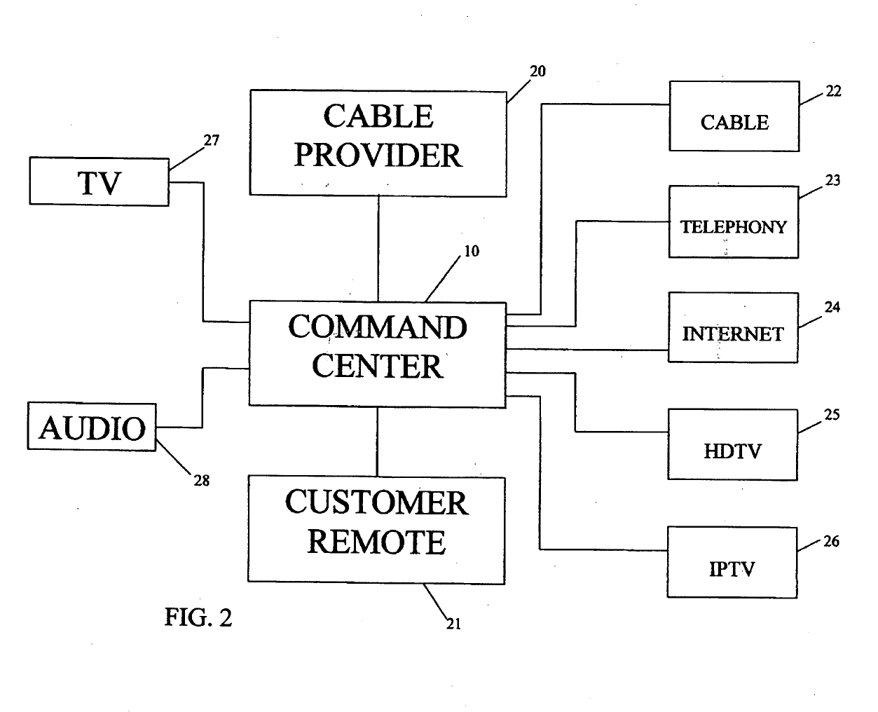

Referring now to FIG. 2, there is shown how command Center 10 accommodates incoming information signals and how access to those signals can be controlled by the cable provider or the consumer.

More particularly, a plurality of incoming information signals is shown at 22-26 consisting of a cable television signal at 22, telephony at 23, the internet at 24, HDTV at 25 and IPTV at 26. It is to be understood that additional incoming information signals could also be accommodated as required.

All of the incoming information signals are applied to Command Center 10. The cable provider at 20 and the customer remote at 21 also has access to Command Center 10. In accordance with the invention the cable provider will be able to selectively enable one or more of the incoming information signals for use by the consumer. In this way the cable provider can install one Command Center at the customer's location capable of handling a plurality of different incoming information signals and enable only those signals desired by the consumer. This eliminates the need for the cable company to provide a separate “box” for each type of information signal, substantially decreasing overhead and substantially increasing ease of installation. Once enabled, the consumer can select any particular input through use of the customer remote at 21. The selected input is then displayed on flat screen TV 27 or applied to an audio reproduction unit 28.

Command Center 10 will include a CPU and the necessary hardware and/or software to decode the incoming information signals for display to the consumer. It will also include the necessary interface with the cable provider to allow the cable provider to selectively enable or disable any of the incoming information stream. The consumer's remote will communicate with the Command Center in a manner known in this art field and will let the consumer to choose from any one of the enabled information streams.

The present invention has been described in relation to various embodiments including but not limited to the preferred embodiment. One of ordinary skill, after reading the foregoing specification, will be able to effect various changes, substitutions of equivalent and other alterations without departing from the broad concepts disclosed herein. It is therefore intended that the scope of Letters Patent granted hereon will be limited only by the definition contained in the appended claims and equivalents thereof.

What is claimed as new and desired to be protected by Letters Patent of the United States is:

1. A wall mountable media control system locatable adjacent a wall mounted video screen comprising:
a wall mountable media control center capable of controlling a plurality of different types of information data and having at least one output connection for each of said different types of information data for connection of wiring from said wall mountable media control center to said wall mounted video screen, at least one of said plurality of different types of information data being selectively enableable by a service provider of said information data, said plurality of different types of information data being accessible by command of a user of said wall mountable media control center; and
at least one wall mountable cowl locatable between said wall mountable media control center and said wall mounted video screen, said wall mounted cowl being sized and shaped to cover said wiring connecting said wall mountable media control center and said wall mounted video screen.

2. The wall mountable media control system of claim 1 wherein said at least one wall mountable cowl comprises a plurality of cowls, said plurality of cowls being interconnectable with one another by integral connection components.

3. The wall mountable media control system of claim 2 wherein said integral connection components of said plurality of cowls are one of dove-tail fittings and tongue-and-groove fittings.

4. The wall mountable media control system of claim 1 further comprising a modular information data receiver addition connectable to said wall mounted media control center, said modular information data receiver addition adapted to receive information data not initially receivable by said wall mountable media control center.

5. The wall mountable media control system of claim 1 wherein said wall mountable media control center further comprises a personal audio device docking station.

6. The wall mountable media control system of claim 1 wherein said wall mountable media control center further comprises an optical media reader.

7. The wall mountable media control system of claim 1 wherein said plurality of different types of information data is selected from the group consisting of cable television, satellite television, HDTV, IPTV, the Internet, telephony, WIFI connectivity, home security monitoring, stereo audio, DVD, digital data recorder, and video game system.

8. The wall mountable media control system of claim 1 wherein said wall mountable media control center further comprises a remote control operable by said user to selectively actuate one or more of said plurality of different types of information data.

9. A wall mountable media control system locatable adjacent a wall mounted video screen comprising:
a wall mountable media control center capable of controlling a plurality of different types of information data and having at least one output connection for each of said different types of information data for connection of wiring from said wall mountable media control center to said wall mounted video screen, at least one of said plurality of different types of information data being selectively enableable by a service provider of said information data, said plurality of different types of information data being accessible by command of a user of said wall mountable media control center; and
a plurality of wall mountable cowls locatable between said wall mountable media control center and said wall mounted video screen, said plurality of wall mounted cowls being sized and shaped to cover said wiring connecting said wall mountable media control center and said wall mounted video screen, said plurality of wall mountable cowls being interconnectable with one another by integral connection components.

10. The wall mountable media control system of claim 9 wherein said integral connection components of said plurality of cowls are one of dove-tail fittings and tongue-and-groove fittings.

11. The wall mountable media control system of claim 9 further comprising a modular information data receiver addition connectable to said wall mounted media control center, said modular information data receiver addition adapted to receive information data not initially receivable by said wall mountable media control center.

12. The wall mountable media control system of claim 9 wherein said wall mountable media control center further comprises a personal audio device docking station.

13. The wall mountable media control system of claim 9 wherein said wall mountable media control center further comprises an optical media reader.

14. The wall mountable media control system of claim 9 wherein said plurality of different types of information data is selected from the group consisting of cable television, satellite television, HDTV, IPTV, the Internet, telephony, WIFI connectivity, home security monitoring, stereo audio, DVD, digital data recorder, and video game system.

15. The wall mountable media control system of claim 9 wherein said wall mountable media control center further comprises a remote control operable by said user to selectively actuate one or more of said plurality of different types of information data.

16. A wall mountable media control system locatable adjacent a wall mounted video screen comprising:
a wall mountable media control center capable of controlling a plurality of different types of information data and having at least one output connection for each of said different types of information data for connection of wiring from said wall mountable media control center to said wall mounted video screen, at least one of said plurality of different types of information data being selectively enableable by a service provider of said information data, said plurality of different types of information data being accessible by command of a user of said wall mountable media control center;
a plurality of wall mountable cowls locatable between said wall mountable media control center and said wall mounted video screen, said plurality of wall mounted cowls being sized and shaped to cover said wiring connecting said wall mountable media control center and said wall mounted video screen, said plurality of wall mountable cowls being interconnectable with one another by integral connection components; and
a modular information data receiver addition connectable to said wall mounted media control center, said modular information data receiver addition adapted to receive information data not initially receivable by said wall mountable media control center.

17. The wall mountable media control system of claim 16 wherein said integral connection components of said plurality of cowls are one of dove-tail fittings and tongue-and-groove fittings.

18. The wall mountable media control system of claim 16 wherein said wall mountable media control center further comprises a personal audio device docking station.

19. The wall mountable media control system of claim 16 wherein said wall mountable media control center further comprises an optical media reader.

20. The wall mountable media control system of claim 16 wherein said plurality of different types of information data is selected from the group consisting of cable television, satellite television, HDTV, IPTV, the Internet, telephony, WIFI connectivity, home security monitoring, stereo audio, DVD, digital data recorder, and video game system.

21. The wall mountable media control system of claim 16 wherein said wall mountable media control center further comprises a remote control operable by said user to selectively actuate one or more of said plurality of different types of information data.
